(19) United States
(12) Patent Application Publication
(10) Pub. No.: US 2026/0215604 A1
(43) Pub. Date: Jul. 30, 2026

(54) HANGING DISPLAY KIT FOR COMMEMORATIVE ITEMS

(71) Applicant: Jason Diwik, Columbus, OH (US)

(72) Inventor: Jason Diwik, Columbus, OH (US)

(21) Appl. No.: 19/531,444

(22) Filed: Feb. 5, 2026

Related U.S. Application Data
(60) Provisional application No. 63/749,947, filed on Jan. 27, 2025.

(51) Int. Cl. A47G 1/17; A47G 1/06; G09F 1/12

(52) U.S. Cl. CPC A47G 1/17; G09F 1/12; A47G 2001/0672

(57) ABSTRACT

A display system for commemorative items comprises a transparent encasement frame with rear-mounted permanent magnets, alignment templates with integrated bubble levels and apertures for precise fixture placement, and ferromagnetic mounting fixtures with adhesive backing. The alignment templates enable rapid, accurate installation of multiple frames in level, evenly-spaced arrangements. Each template includes frame-positioning areas with apertures corresponding to magnet locations on the frames. The ferromagnetic fixtures are dimensioned larger than the frame magnets, providing adjustment tolerance for fine-tuning frame position after installation. The transparent encasement protects collectible items while the magnetic mounting system allows easy repositioning without wall damage, addressing the needs of collectors displaying baseball cards, comic books, and similar memorabilia.

### TECHNICAL FIELD

The present invention relates to display systems for commemorative items, and more particularly to a magnetic mounting system with alignment templates for precise, level installation of multiple protective encasement frames.

### BACKGROUND OF THE INVENTION

Commemorative items such as baseball cards, comic books, magazines, and similar collectibles often have significant monetary and sentimental value. These items typically comprise wood-fiber-based materials that degrade when exposed to air, humidity, heat, and light over extended periods. While transparent protective enclosures can preserve such items, displaying multiple items on a wall in a level, evenly-spaced arrangement presents challenges to collectors.

Conventional picture hanging methods, such as nails, hooks, or adhesive strips, require individual measurements and alignment for each frame. Installing multiple frames in precise horizontal or vertical alignment typically requires repeated use of measuring tools and levels, a time-consuming and error-prone process. Furthermore, traditional hanging methods provide limited adjustability once installed, making repositioning difficult without creating new holes in the wall.

Magnetic mounting systems for artwork and frames exist in the prior art. However, these systems typically lack integrated alignment tools for installing multiple frames in precise, evenly-spaced arrangements. Gallery wall template guides that show frame outlines exist but do not provide integrated magnetic mounting fixtures or precision apertures for fixture placement.

There remains a need for a display system that combines protective encasement of commemorative items with a simplified, precise method for mounting multiple frames in level, evenly-spaced arrangements, while also allowing easy repositioning and removal without wall damage.

### SUMMARY OF THE INVENTION

The present invention provides a commemorative item display system comprising: (1) a transparent encasement frame having a rear surface with at least two magnets affixed thereto at spaced-apart locations; (2) alignment templates configured for both horizontal and vertical frame orientations, each template having a plurality of frame-positioning areas with apertures corresponding to magnet locations; (3) a bubble level permanently affixed to each template for ensuring level installation; and (4) ferromagnetic mounting fixtures configured to attach to a wall surface and magnetically couple with the frame magnets.

The alignment templates are dimensioned to position multiple frames in evenly-spaced arrangements. Each frame-positioning area on the template includes apertures that correspond to the spacing of magnets on the encasement frame's rear surface. By placing the template against a wall, leveling it using the integrated bubble level, and installing ferromagnetic fixtures through the apertures, a user can quickly and accurately position multiple mounting locations.

The ferromagnetic fixtures are dimensioned larger than the magnets on the frame, providing a tolerance range for minor positional adjustments after installation. Each fixture includes an adhesive surface protected by a removable covering, enabling secure wall attachment without nails or screws.

The transparent encasement frame protects commemorative items from environmental degradation while allowing viewing from multiple angles. The magnetic coupling between frame-mounted magnets and wall-mounted ferromagnetic fixtures provides sufficient holding force for secure mounting while permitting easy removal and repositioning.

One advantage of the present invention is the simplified installation process enabled by the alignment templates with integrated bubble levels, which eliminates repetitive measuring and leveling for each individual frame.

Another advantage is the magnetic mounting system's adjustability, allowing frames to be easily repositioned within the tolerance provided by the oversized ferromagnetic fixtures without removing the wall-mounted fixtures.

A further advantage is the preservation capability of the transparent encasement frame, which protects valuable commemorative items from environmental damage while displaying them.

Still another advantage is the system's versatility, accommodating both horizontal (landscape) and vertical (portrait) frame orientations through dedicated

### BRIEF DESCRIPTION OF THE DRAWINGS

FIG. 1: is a front view of encasement frame showing transparent construction with commemorative item (baseball card) visible through front face.

FIG. 2: is a rear view of encasement frame showing wall-facing surface with two magnets positioned at opposite ends and reverse side of commemorative item visible through transparent material.

FIG. 3: is a side cross-sectional view of encasement frame showing spatial relationship of frame structure, encased commemorative item, and magnets affixed to rear surface.

FIG. 4: is a horizontal alignment template showing plurality of frame-positioning areas with aperture pairs for ferromagnetic fixture placement, and permanently affixed bubble level for horizontal frame orientation (landscape).

FIG. 5: is a vertical alignment template showing plurality of frame-positioning areas with aperture pairs for ferromagnetic fixture placement, and permanently affixed bubble level for vertical frame orientation (portrait).

FIG. 6: is a ferromagnetic mounting fixture showing frame-facing surface, adhesive-coated wall-facing surface with protective peel-away covering, and side profile view.

### DETAILED DESCRIPTION

The following detailed description references the accompanying drawings that illustrate specific embodiments of the invention. Other embodiments having different structures and operations do not depart from the scope of the present invention.

The commemorative item display system provides an integrated solution for protecting and displaying collectible items such as baseball cards, comic books, magazines, trading cards, photographs, and similar memorabilia. The system comprises four principal components: transparent encasement frames, alignment templates for horizontal and vertical orientations, ferromagnetic mounting fixtures, and permanent magnets affixed to the frames.

The system enables users to quickly install multiple frames in precise, level, evenly-spaced arrangements without requiring individual measurements for each frame. The magnetic mounting method provides secure attachment while permitting easy removal and repositioning, addressing the needs of collectors who frequently rearrange their displays.

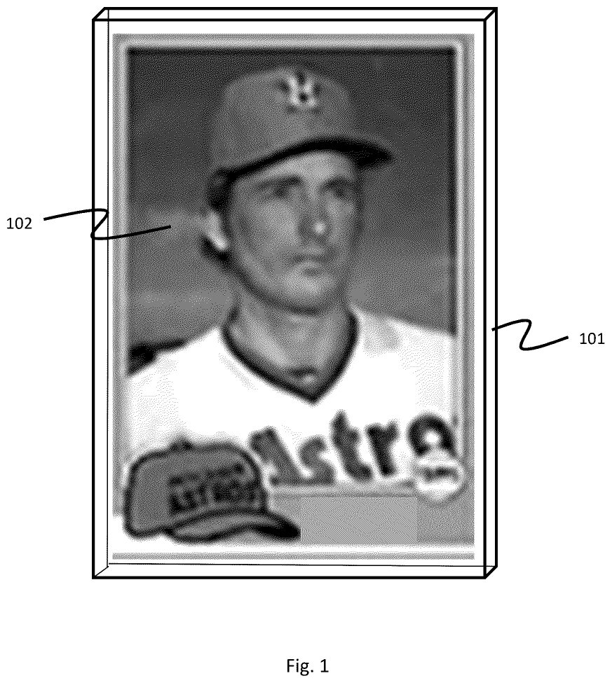

Referring to FIG. 1, the encasement frame (101) comprises a transparent housing dimensioned to receive and protect a commemorative item. In the illustrated embodiment, the frame is configured for standard-sized baseball cards, though the dimensions may be adapted for other collectible items including, but not limited to, comic books, trading cards, photographs, magazine covers, stamps, or documents.

The frame is constructed from transparent materials, which may include acrylic, polycarbonate, polyethylene terephthalate (PET), glass, or other transparent polymers. The transparent construction allows viewing of the commemorative item (102) from the front face, as shown in FIG. 1. The frame provides a sealed or semi-sealed environment that protects the enclosed item from dust, humidity, oils from handling, and other environmental contaminants that accelerate degradation of paper-based materials.

The frame structure may comprise two transparent sheets joined at their perimeters, or may include a frame border with transparent front and back panels. The encasement may be permanently sealed or may include an opening mechanism (not shown) for inserting or replacing commemorative items.

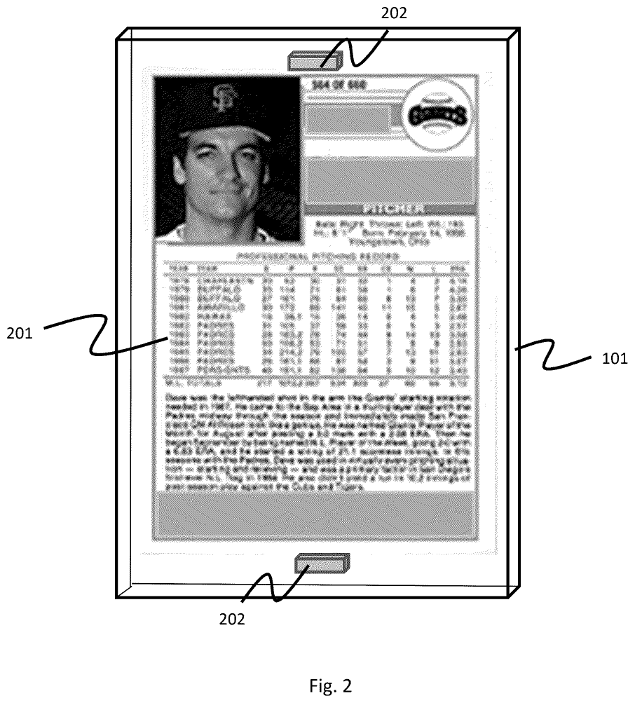

Referring to FIG. 2, the rear surface of the encasement frame (101) faces the wall when mounted and includes at least two magnets (202) affixed at spaced-apart locations. In the illustrated embodiment, the magnets are positioned near opposite ends of the frame, specifically near the top and bottom edges. This spacing provides stability and prevents rotation of the frame when mounted.

The magnets (202) may comprise permanent magnets including neodymium magnets, ferrite magnets, alnico magnets, or samarium-cobalt magnets. Neodymium magnets are preferred for their high magnetic strength relative to size, providing secure mounting in a compact form factor. The magnets may be circular, rectangular, or other shapes, and are affixed to the frame rear surface using adhesive, mechanical fasteners, or embedding during frame manufacture.

The through-transparent nature of the frame allows the reverse side of the commemorative item (201) to be viewed, as shown in FIG. 2. For baseball cards and similar double-sided collectibles, this feature enables viewing of both faces without removing the item from the protective encasement.

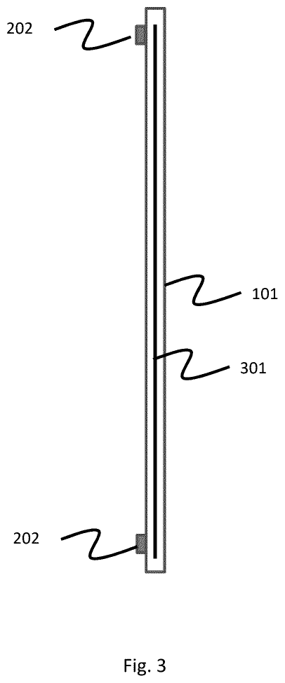

FIG. 3 illustrates a side cross-sectional view showing the spatial relationships within the assembled frame. The encasement frame structure (101) encloses the commemorative item (301), with the magnets (202) affixed to the wall-facing rear surface. The thickness of the frame accommodates the commemorative item while maintaining a low profile suitable for wall mounting.

The alignment templates constitute a key inventive aspect of the system, enabling rapid, precise installation of multiple frames in level, evenly-spaced arrangements.

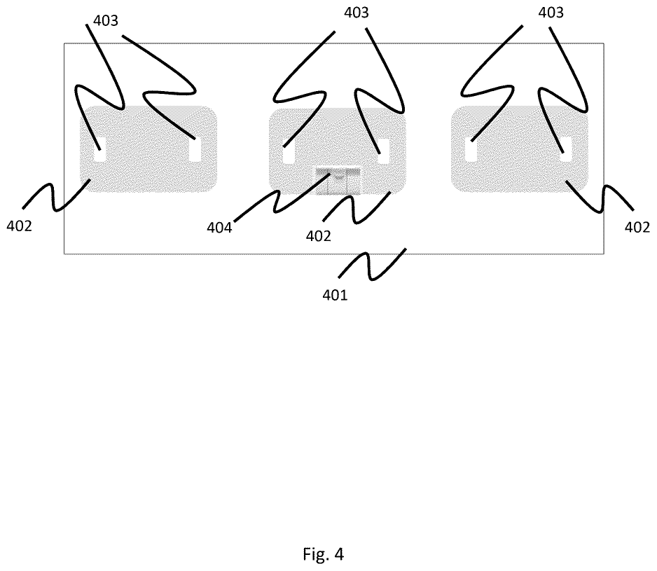

Referring to FIG. 4, the horizontal alignment template (401) is configured for mounting frames in landscape orientation, where the longer dimension of the rectangular frame extends horizontally. The template comprises a substantially planar structure, which may be fabricated from cardboard, plastic sheet, foam board, or other semi-rigid materials. The template dimensions are selected to span the intended display area width.

The template includes a plurality of frame-positioning areas (402), each corresponding to the dimensions and intended position of an encasement frame. These areas may be outlined, colored, or otherwise visually indicated on the template surface to guide placement. The frame-positioning areas are evenly spaced from one another at predetermined intervals, which may be selected based on aesthetic preferences or the wall dimensions.

Each frame-positioning area includes a pair of apertures (403) positioned to correspond with the spacing of the magnets (202) on the encasement frame rear surface. These apertures serve as guides for placement of the ferromagnetic mounting fixtures. The apertures may be holes, cutouts, or marked positions that allow the user to accurately position fixtures at the precise locations where frame magnets will align.

Critically, the horizontal alignment template includes a bubble level (404) permanently affixed to the template. This integrated level eliminates the need for separate leveling tools and ensures that all frames installed using the template will be level with one another and with the horizontal plane. The bubble level may be adhered, mechanically fastened, or integrated into the template structure.

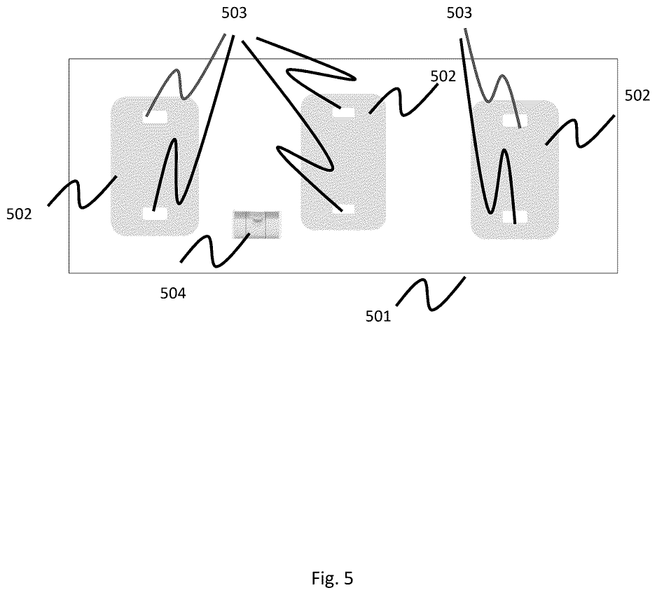

FIG. 5 illustrates the vertical alignment template (501), which is configured for mounting frames in portrait orientation where the longer dimension extends vertically. The vertical template structure parallels that of the horizontal template, including frame-positioning areas (502), aperture pairs (503) for ferromagnetic fixture placement, and a permanently affixed bubble level (504).

The provision of separate templates for horizontal and vertical orientations accommodates different display preferences. Some collectors prefer landscape orientation for certain items (wide photographs, horizontally-formatted cards) while others prefer portrait orientation (vertically-formatted cards, comic book covers). The system's dual-template design provides flexibility for both arrangements.

In use, a user selects the appropriate template (horizontal or vertical) based on the desired frame orientation. The template is positioned against the wall at the intended display location. Using the integrated bubble level, the user adjusts the template position until the bubble indicates level alignment. The template may be temporarily secured to the wall using removable adhesive strips, painter's tape, or by holding.

With the template leveled and positioned, the user installs ferromagnetic mounting fixtures at each aperture location. After all fixtures are installed, the template is removed, leaving an array of precisely positioned, level mounting points ready to receive the encasement frames.

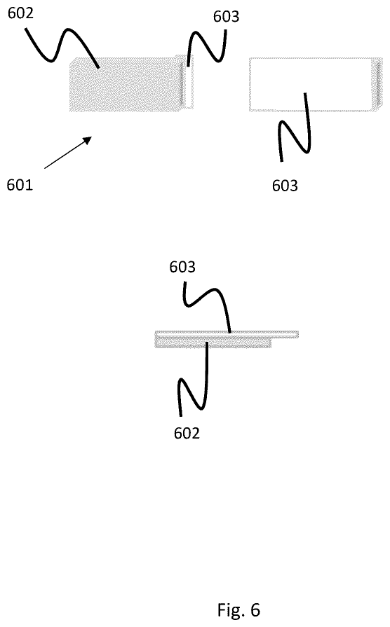

Referring to FIG. 6, the ferromagnetic mounting fixture (601) comprises a component that adheres to the wall surface and provides a magnetically attractive surface for coupling with the frame-mounted magnets. Each fixture includes two functionally distinct surfaces: a frame-facing surface (602) and a wall-facing surface.

The fixture body comprises a ferromagnetic material, meaning a material that is attracted to magnets. Suitable materials include mild steel, iron, ferritic stainless steel, or other ferromagnetic alloys or composites. The fixture need not be a permanent magnet itself; rather, it provides a magnetically attractive surface that couples with the permanent magnets on the frame.

The frame-facing surface (602) is the smooth surface that faces outward from the wall when installed. This surface couples magnetically with the magnets (202) on the frame rear surface. The surface may be plated, coated, or finished to prevent rust and provide smooth sliding contact with the frame.

The wall-facing surface is coated with an adhesive for permanent or semi-permanent attachment to the wall. A protective peel-away covering (603) protects the adhesive surface prior to installation. This covering may comprise wax paper, plastic film, or release liner that is removed immediately before pressing the fixture against the wall. Suitable adhesives include pressure-sensitive adhesives, double-sided foam tape, or other adhesives providing strong bonding to common wall surfaces such as drywall, plaster, wood, or painted surfaces.

A critical dimensional feature is that the ferromagnetic fixtures are larger in both lateral dimensions than the magnets (202) on the frame. This size differential provides a tolerance range for adjustment. When a frame is initially positioned against the wall-mounted fixtures, the magnets attract to the fixtures and hold the frame in place. However, because the fixtures are larger than the magnets, the frame can be shifted slightly in any direction parallel to the wall surface while maintaining magnetic coupling. This adjustability allows fine-tuning of frame position without moving the fixtures themselves.

Once the frame is positioned precisely as desired, the magnetic force provides sufficient friction to maintain that position. The magnetic coupling strength is selected to securely support the frame weight against gravity while permitting deliberate repositioning by the user. Typical magnetic holding forces range from 2 to 20 pounds per magnet pair, depending on frame size and weight.

The installation process demonstrates the integrated functionality of the system components:
1. The user selects the appropriate alignment template (horizontal or vertical) based on the desired frame orientation.
2. The template is positioned against the wall at the intended display location and adjusted until the permanently affixed bubble level indicates level alignment.
3. The template may be temporarily secured using painter's tape or similar removable adhesive.
4. For each frame-positioning area on the template, the user removes the protective covering from two ferromagnetic fixtures and presses them firmly against the wall at the aperture locations. The adhesive secures the fixtures to the wall.
5. After all fixtures are installed, the template is removed, leaving precisely positioned, level mounting points.
6. The user positions an encasement frame against the wall, aligning the frame-mounted magnets with the wall-mounted ferromagnetic fixtures. The magnetic attraction guides the frame into approximate position.
7. The frame is adjusted as needed within the tolerance provided by the oversized fixtures to achieve the exact desired position. The magnetic coupling maintains this position.
8. Additional frames are installed in the same manner at the remaining fixture locations, resulting in a level, evenly-spaced display of multiple frames.

This process eliminates the need for individual measurements, repeated leveling, or marking multiple installation points. The template-guided method dramatically reduces installation time and improves accuracy compared to conventional hanging methods.

The system provides several functional advantages:
Preservation: The sealed or semi-sealed transparent encasement protects valuable commemorative items from environmental degradation while allowing full visibility.
Precision: The alignment templates with integrated bubble levels ensure accurate, level installation without repeated measurements.
Adjustability: The magnetic mounting system allows easy repositioning within the fixture tolerance and complete removal/reinstallation without wall damage.
Versatility: Separate horizontal and vertical templates accommodate different display preferences and item orientations.
Ease of use: The integrated system reduces installation time and eliminates the need for multiple separate tools.

Various modifications and alternative embodiments may be implemented without departing from the scope of the invention:

The number of magnets and corresponding fixture apertures may be varied. While two magnets positioned at opposite ends provide stable mounting, three or more magnets could be used for larger or heavier frames.

The frame dimensions may be adapted for different commemorative item sizes, including trading cards, comic books (standard, silver age, golden age sizes), photographs (4×6, 5×7, 8×10 inches), magazine covers, stamps, or documents.

The transparent material may comprise various polymers, glass, or composite materials selected for clarity, UV resistance, impact resistance, or other properties.

The alignment templates may include additional features such as printed dimensions, alternative spacing patterns, or removable sections for customization.

The ferromagnetic fixtures may include decorative finishes, alternative shapes, or additional features such as integrated hooks for supplementary hanging methods.

Multiple template designs may be provided in a single kit to accommodate different spacing preferences or wall dimensions.

The system may be adapted for mounting on non-wall surfaces such as doors, cabinets, or freestanding panels.

While the detailed description focuses on commemorative items such as baseball cards, the system is equally applicable to other flat displayable items including certificates, awards, tickets, currency, pressed flowers, or artistic prints.

What is claimed is:

1. A display system for commemorative items, comprising:
a transparent encasement frame having a front surface, a rear surface, and an interior space dimensioned to receive a commemorative item, wherein the rear surface has at least two permanent magnets affixed thereto at spaced-apart locations;
a first alignment template having a front face and a plurality of frame-positioning areas formed thereon, each frame-positioning area comprising at least two apertures positioned to correspond with the spaced-apart locations of the at least two permanent magnets, wherein the first alignment template further comprises a bubble level permanently affixed thereto;
a plurality of ferromagnetic mounting fixtures, each fixture comprising:
a fixture body formed of ferromagnetic material having a frame-facing surface and a wall-facing surface; and
an adhesive layer disposed on the wall-facing surface and configured to attach the fixture to a wall surface;
wherein each of the ferromagnetic mounting fixtures is dimensioned larger in at least two orthogonal directions than the permanent magnets to provide a positional adjustment tolerance.

2. The display system of claim 1, wherein the transparent encasement frame comprises a sealed enclosure configured to protect the commemorative item from environmental exposure.

3. The display system of claim 1, wherein the plurality of frame-positioning areas on the first alignment template are evenly spaced from one another at a predetermined interval.

4. The display system of claim 1, wherein the at least two permanent magnets are positioned at opposite ends of the rear surface of the encasement frame.

5. The display system of claim 1, further comprising:
a second alignment template having a front face and a plurality of frame-positioning areas formed thereon, each frame-positioning area of the second alignment template comprising at least two apertures;
wherein the first alignment template is configured for horizontal orientation of the encasement frame and the second alignment template is configured for vertical orientation of the encasement frame.

6. The display system of claim 5, wherein the second alignment template further comprises a second bubble level permanently affixed thereto.

7. The display system of claim 1, wherein the transparent encasement frame is dimensioned to receive a baseball card.

8. The display system of claim 1, wherein the at least two permanent magnets comprise neodymium magnets.

9. The display system of claim 1, wherein each of the plurality of ferromagnetic mounting fixtures further comprises a removable protective covering disposed over the adhesive layer.

10. The display system of claim 1, wherein the commemorative item comprises a material selected from the group consisting of: baseball card, trading card, comic book, magazine, photograph, stamp, and document.

11. A method of installing a display system for commemorative items, comprising the steps of:
positioning an alignment template against a wall surface, the alignment template having a plurality of frame-positioning areas, each area having at least two apertures, wherein the alignment template further comprises a permanently affixed bubble level;
adjusting the alignment template until the bubble level indicates level alignment;
installing a plurality of ferromagnetic mounting fixtures to the wall surface by positioning each fixture at an aperture location on the alignment template;
removing the alignment template from the wall surface;
positioning a transparent encasement frame having at least two permanent magnets affixed to a rear surface thereof against the wall surface such that the at least two permanent magnets magnetically couple with corresponding ferromagnetic mounting fixtures; and
adjusting the encasement frame position while maintaining the magnetic coupling to achieve a desired final position.

12. The method of claim 11, wherein the step of installing a plurality of ferromagnetic mounting fixtures comprises:
removing a protective covering from an adhesive surface of each fixture; and
pressing the adhesive surface against the wall surface at the aperture location.

13. The method of claim 11, further comprising the step of:
inserting a commemorative item into the transparent encasement frame prior to the step of positioning the encasement frame against the wall surface.

14. The method of claim 11, wherein the adjustment of the encasement frame position is accomplished without moving the ferromagnetic mounting fixtures.

15. The method of claim 11, wherein the plurality of frame-positioning areas are evenly spaced on the alignment template such that multiple encasement frames installed according to the method are evenly spaced from one another.

16. The method of claim 11, further comprising the step of:
repeating the steps of positioning and adjusting for a plurality of additional encasement frames at remaining ferromagnetic mounting fixtures installed using the alignment template.

17. A kit for displaying and mounting commemorative items, comprising:
at least one transparent encasement frame dimensioned to receive a commemorative item and having at least two permanent magnets affixed to a rear surface at spaced-apart locations;
a horizontal alignment template having a plurality of first frame-positioning areas, each first frame-positioning area comprising at least two apertures corresponding to the spaced-apart locations of the permanent magnets, the horizontal alignment template further comprising a first bubble level permanently affixed thereto;
a vertical alignment template having a plurality of second frame-positioning areas, each second frame-positioning area comprising at least two apertures corresponding to the spaced-apart locations of the permanent magnets, the vertical alignment template further comprising a second bubble level permanently affixed thereto; and
a plurality of ferromagnetic mounting fixtures, each fixture having an adhesive surface configured to attach to a wall and a frame-facing surface configured to magnetically couple with the permanent magnets;
wherein the ferromagnetic mounting fixtures are dimensioned larger than the permanent magnets to provide positional adjustment tolerance.

18. The kit of claim 17, further comprising a plurality of transparent encasement frames, each having at least two permanent magnets affixed to a rear surface.

19. The kit of claim 17, wherein the at least one transparent encasement frame is dimensioned to receive a collectible selected from the group consisting of: baseball card, trading card, comic book cover, magazine cover, photograph, and stamp.

20. The kit of claim 17, wherein the plurality of first frame-positioning areas on the horizontal alignment template and the plurality of second frame-positioning areas on the vertical alignment template are each evenly spaced to facilitate installation of multiple frames in a regular pattern.
